(19) United States
(12) Patent Application Publication
(10) Pub. No.: US 2026/0160259 A1
(43) Pub. Date: Jun. 11, 2026

(54) METHOD FOR ADJUSTING OSCILLATION ANGLE OF FAN AND FAN

(71) Applicant: SINOWELL (SHANGHAI) CO., LTD., Shanghai (CN)

(72) Inventors: Jia LUO, Shanghai (CN); Yun Fei DUAN, Shanghai (CN); Jun Rong YI, Shanghai (CN); Liang ZHOU, Shanghai (CN); Jie Feng HUANG, Shanghai (CN)

(21) Appl. No.: 19/404,471

(22) Filed: Dec. 1, 2025

(30) Foreign Application Priority Data
Dec. 10, 2024 (CN) 202411812012.4
Dec. 10, 2024 (CN) 202423042347.0

(51) Int. Cl. F04D 25/10; H02P 8/20

(52) U.S. Cl. CPC F04D 25/105; H02P 8/20

(57) ABSTRACT

Provided are a method for adjusting the oscillation angle of the fan and a fan. The method includes the following steps: controlling the air outlet assembly to oscillate between a first limit position and a second limit position, and acquiring a signal emitted by the fan in real time; determining that the air outlet assembly oscillates between the first limit position and an intermediate position when a first signal is acquired; determining that the air outlet assembly oscillates between the intermediate position and the second limit position when a second signal is acquired; and determining that the air outlet assembly is at the intermediate position when a transition between the first signal and the second signal is acquired.

### CROSS-REFERENCE TO RELATED APPLICATION

This application claims priority to Chinese Patent Application No. 202411812012.4 filed on Dec. 10, 2024, and Chinese Patent Application No. 202423042347.0 filed on Dec. 10, 2024, the disclosures of which are incorporated herein by reference in their entirety.

### TECHNICAL FIELD

The present disclosure relates to the technical field of fans, and more particularly, to a method for adjusting an oscillation angle of a fan and the fan.

### BACKGROUND

Oscillating fans are common household appliances that increase comfort by oscillating leftward and rightward to expand the range of air delivery. However, conventional oscillating fans have certain technical challenges in controlling the oscillation angle, especially in accurately detecting the center point of oscillation and determining whether the fan has oscillated to the left-side or right-side from the center. This results in less precise and flexible control over the oscillation angle of fan and prevents accurate angle adjustment.

Therefore, there is an urgent need for a method for adjusting the oscillation angle of a fan and the fan to solve the above problems.

### SUMMARY

The objective of the present disclosure is to provide a method for adjusting the oscillation angle of a fan and the fan, which are capable of accurately detecting the current position of an air outlet assembly by obtaining information of a first signal and a second signal, thereby reducing the difficulty of controlling the oscillation angle of the air outlet assembly in subsequent operations.

To achieve the above objective, the present disclosure provides the following technical solution:

In one aspect, the present disclosure provides a method for adjusting the oscillation angle of a fan. The fan includes an air outlet assembly, the air outlet assembly being configured to oscillate to a first limit position, an intermediate position, and a second limit position, wherein the intermediate position is located between the first limit position and the second limit position; The method includes the following steps:

Controlling the air outlet assembly to oscillate between the first limit position and the second limit position and acquiring a signal emitted by the fan in real time;

In response to acquiring a first signal emitted by the fan, determining that the air outlet assembly oscillates to a position between the first limit position and the intermediate position; In response to acquiring a second signal emitted by the fan, determining that the air outlet assembly oscillates to a position between the intermediate position and the second limit position; and In response to detecting a transition between the first signal and the second signal emitted by the fan, determining that the air outlet assembly oscillates to the intermediate position.

In another aspect, the disclosure provides a fan, the fan includes an oscillating assembly, a fixed shaft, an air outlet assembly, and a control assembly. The oscillating assembly includes an oscillating member, a driving member, and a photoelectric detection switch. The photoelectric detection switch and the driving member are both disposed on the oscillating member, and the photoelectric detection switch is provided with a detection slot. The fixed shaft is provided with a baffle, and the driving member drives the oscillating member to rotate relative to the fixed shaft. The air outlet assembly connects to the oscillating member and oscillates with the oscillating assembly to a first limit position, an intermediate position, and a second limit position, wherein the intermediate position is located between the first limit position and the second limit position. When the air outlet assembly oscillates with the oscillating assembly to a position between the first limit position and the intermediate position, the baffle is located within the detection slot, and the photoelectric detection switch outputs a first signal. When the air outlet assembly oscillates with the oscillating assembly to a position between the intermediate position and the second limit position, the baffle is located outside the detection slot, and the photoelectric detection switch outputs a second signal. The control assembly is electrically connected to the photoelectric detection switch and the driving member.

### BRIEF DESCRIPTION OF DRAWINGS

FIG. 1 is a flowchart of a method for adjusting the oscillation angle of a fan according to an embodiment of the present disclosure.

FIG. 2 is a schematic structural diagram of the fan according to an embodiment of the present disclosure.

FIG. 3 is an exploded view of the fan according to an embodiment of the present disclosure.

FIG. 4 is a partial exploded view of the fan according to an embodiment of the present disclosure.

FIG. 5 is a schematic structural diagram of the fixed shaft according to an embodiment of the present disclosure.

The reference numerals in the figures are as follows:

1. oscillating assembly, 11. oscillating member, 111. connecting seat, 112. mounting seat, 1121. first through hole, 1122. receiving groove, 1123. first limiting protrusion, 113. bearing, 114. outer cover, 12. driving member, 121. driver, 122. driving gear, 13. photoelectric detection switch, 131. detection slot, 2. fixed shaft, 21. semi-circular part, 211. baffle, 212. toothed groove, 213. second limiting protrusion, 3. air outlet assembly, 31. housing, 32. fan blade, 4. control assembly, 41. button, 42. MCU, 5. clamping assembly, 51. knob, 52. connecting member, 521. connecting arm, 522. connecting housing, 53. clamping member, 531. clip, 5311. clip arm, 5312. clamping hole, 532. cushion pad, 520. hinge protrusion, 530. hinge groove.

### DETAILED DESCRIPTION

The present disclosure will be further described in detail below in conjunction with the drawings and embodiments. It should be understood that the specific embodiments described herein are only intended to explain the present disclosure and are not intended to limit the scope of the present disclosure. In addition, it should be noted that, for the sake of clarity, the drawings only show portions relevant to the present disclosure rather than all structures.

In the description of the present disclosure, unless otherwise explicitly specified and limited, the terms “connected,” “coupled,” and “fixed” should be understood in a broad sense. For example, they may refer to fixed connections or detachable connections, or integral formations; they may refer to mechanical connections or electrical connections; they may refer to direct connections or indirect connections via an intermediate medium; they may also refer to internal communication between two components or interaction relationships between two components. A person skilled in the art can understand the specific meaning of these terms in the context of the present disclosure according to specific circumstances.

In the present disclosure, unless otherwise explicitly specified and limited, when a first feature is described as being “on” or “above” a second feature, it may include the first and second features being in direct contact, or the first and second features not being in direct contact but in contact via other features therebetween. Moreover, when a first feature is described as being “on,” “above,” or “over” a second feature, it includes the first feature being directly above or obliquely above the second feature, or merely indicating that the horizontal height of the first feature is higher than that of the second feature. When a first feature is described as being “under,” “below,” or “beneath” a second feature, it includes the first feature being directly below or obliquely below the second feature, or merely indicating that the horizontal height of the first feature is lower than that of the second feature.

In the description of the embodiments of the present disclosure, terms such as “upper,” “lower,” “left,” “right,” and other orientation or positional relationships are based on the orientations or positions shown in the drawings. They are only provided for convenience of description and simplification of operations, and are not intended to indicate or imply that the devices or components must have a specific orientation, or must be constructed and operated in a specific orientation. Therefore, they should not be construed as limiting the present disclosure. In addition, the terms “first” and “second” are only used to distinguish different elements in the description and do not carry any special meaning.

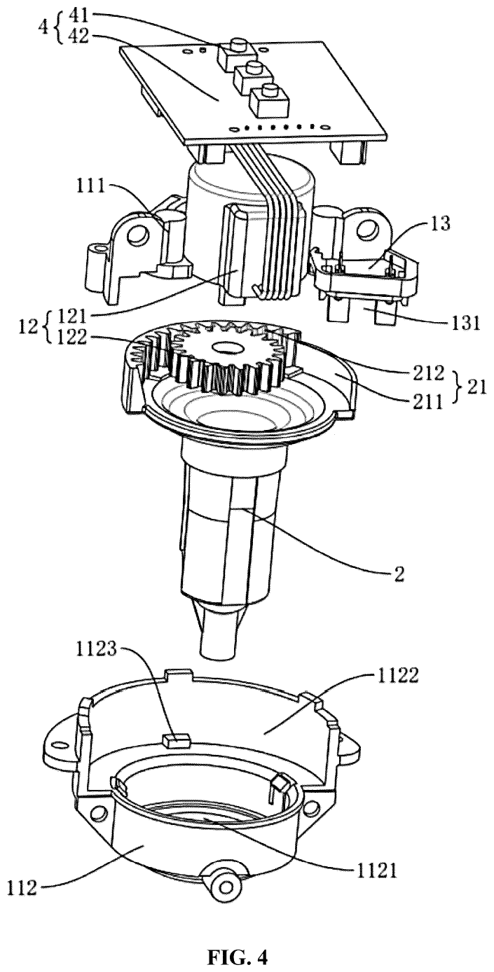

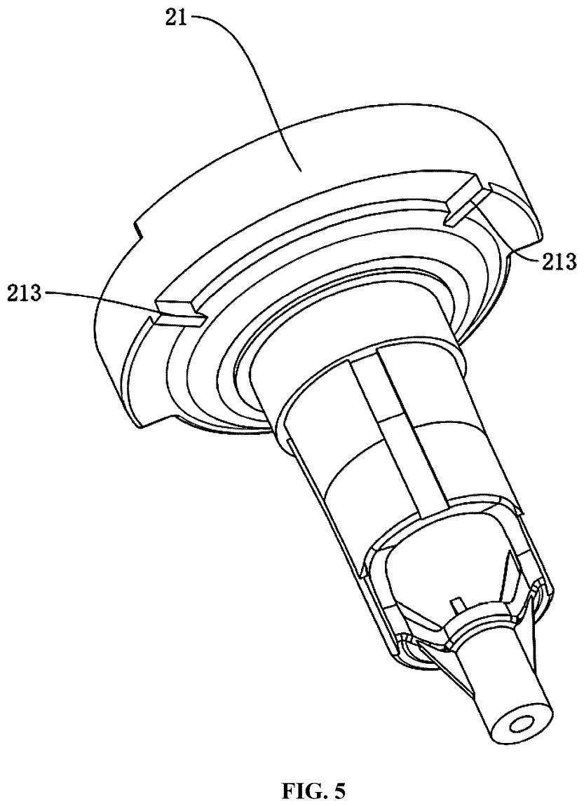

As shown in FIGS. 1-5, the present disclosure provides a method for adjusting the oscillation angle of a fan. The fan includes an air outlet assembly 3, which is capable of oscillating to a first limit position, an intermediate position, and a second limit position. The intermediate position is located between the first limit position and the second limit position. The method includes the following steps.
In S1, the air outlet assembly 3 is controlled to oscillate between the first limit position and the second limit position, and signals emitted by the fan are acquired in real time.
In S21, in response to acquiring a first signal emitted by the fan, the air outlet assembly 3 is determined to be oscillated to a position between the first limit position and the intermediate position.
In S22, in response to acquiring a second signal emitted by the fan, the air outlet assembly 3 is determined to be oscillated to a position between the intermediate position and the second limit position.
In S23, in response to detecting a transition between the first signal and the second signal, the air outlet assembly 3 is determined to be oscillated to the intermediate position.

During fan operation, the air outlet assembly 3 oscillates between the first limit position and the second limit position. When receiving the first signal, it is determined that the air outlet assembly 3 oscillates to a position between the first limit position and the intermediate position. When receiving the second signal, it is determined that the air outlet assembly 3 oscillates to a position between the intermediate position and the second limit position. When detecting a transition between the first signal and the second signal, it is determined that the air outlet assembly 3 is at the intermediate position. The present disclosure addresses the problem in conventional fans that the center point of oscillation cannot be accurately detected, and it is hard to determine whether the air outlet assembly 3 is on the left or right side of the center point. By obtaining information from the first signal and the second signal, the current position of the air outlet assembly 3 is accurately detected, thereby reducing the difficulty of controlling the oscillation angle of the air outlet assembly 3 in subsequent operations.

In one or more embodiments, the method further includes an oscillation angle setting method. The oscillation angle setting method includes the following steps.
In S31, the air outlet assembly 3 is controlled to oscillate from the intermediate position to the first limit position.
In S32, a time period T1 during which the air outlet assembly oscillates from the intermediate position to the first limit position is acquired.
In S33, the oscillation angle of the air outlet assembly is divided into M oscillation angle levels.
In S34, when the fan operates at the N-th oscillation angle level, the air outlet assembly is configured to oscillate leftward and rightward from the intermediate position for a time period of N*T1/M, respectively. Where N and M are positive integers.

In this embodiment, according to the number of oscillation angle levels, the time period from the intermediate position to the first and second limit positions on the left and right sides is divided symmetrically, so as to achieve precise control of the oscillation angle of the air outlet assembly 3 at different oscillation angle levels, and to enable the air outlet assembly 3 to oscillate leftward and rightward equidistantly based on the intermediate position.

For example, the oscillation angle of the air outlet assembly 3 is divided into three oscillation angle levels. When the fan operates at the first oscillation angle level, the oscillation time during which the air outlet assembly 3 oscillates from the intermediate position towards left or right is 1*T1/3. When the fan operates at the second oscillation angle level, the oscillation time during which the air outlet assembly 3 oscillates from the intermediate position towards left or right is 2*T1/3. When the fan operates at the third oscillation angle level, the oscillation time during which the air outlet assembly 3 oscillates from the intermediate position towards left or right is 3*T1/3.

In one or more embodiments, the method for adjusting the oscillation angle of the fan further includes the following steps.
In S41, limit structures at both ends of the oscillating stroke of the air outlet assembly 3 are provided.
In S42, the air outlet assembly 3 is driven to oscillate by using a stepper motor.
In S43, a variation value of a current of the stepper motor is acquired, and the air outlet assembly 3 is determined to oscillate to the first limit position or the second limit position when the current of the stepper motor increases.

In this embodiment, the oscillate of the air outlet assembly 3 is driven by a stepper motor. When the air outlet assembly 3 reaches the first limit position or the second limit position, the limit structures prevent the air outlet assembly 3 from continuing to oscillate. At this moment, the increase in the current of the stepper motor can be detected, thereby determining that the air outlet assembly 3 has reached the first limit position or the second limit position.

In one or more embodiments, the method for adjusting the oscillation angle of the fan further includes an oscillation angle setting method. The oscillation angle setting method includes the following steps.
In S51, the stepper motor is controlled to drive the air outlet assembly 3 to oscillate from the intermediate position to the first limit position.
In S52, the number of steps A of the stepper motor when the air outlet assembly 3 oscillates from the intermediate position to the first limit position is obtained.
In S53, the oscillation angle of the air outlet assembly is divided into M oscillation angle levels.
In S54, when the fan operates at the N-th oscillation angle level, the stepper motor is configured to drive the air outlet assembly 3 to oscillate leftward and rightward from the intermediate position by N*A/M steps, respectively. Where A, N and M are positive integers.

In this embodiment, according to the number of the oscillation angle levels, the number of steps of the stepper motor from the intermediate position to the first and second limit positions on the left and right sides is divided symmetrically, so as to achieve precise control of the oscillation angle of the air outlet assembly 3 at different oscillation angle levels, and to enable the air outlet assembly 3 to oscillate leftward and rightward equidistantly based on the intermediate position.

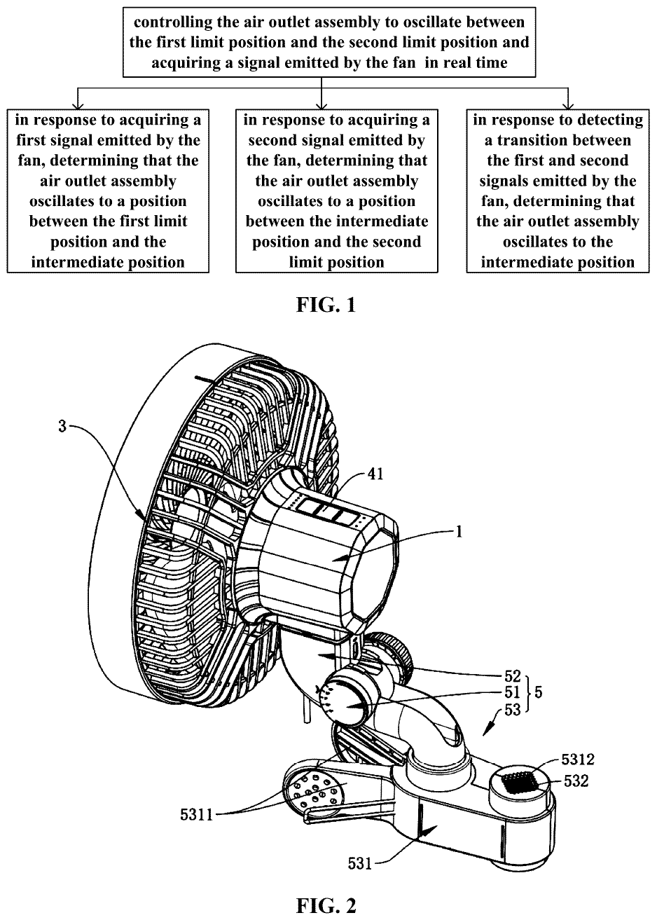

As shown in FIGS. 2-4, the present disclosure also provides a fan, which includes an oscillating assembly 1, a fixed shaft 2, an air outlet assembly 3, and a control assembly 4. The oscillating assembly 1 includes an oscillating member 11, a driving member 12, and a photoelectric detection switch 13. The photoelectric detection switch 13 and the driving member 12 are both disposed on the oscillating member 11, and the photoelectric detection switch 13 is provided with a detection slot 131. The fixed shaft 2 is provided with a baffle 211, and the driving member 12 drives the oscillating member 11 to rotate relative to the fixed shaft 2. The air outlet assembly 3 is connected to the oscillating member 11 and is capable of oscillating along with the oscillating assembly 1 to a first limit position, an intermediate position, and a second limit position. The intermediate position located between the first limit position and the second limit position. When the air outlet assembly 3 oscillates with the oscillating assembly 1 between the first limit position and the intermediate position, the baffle 211 is located within the detection slot 131, and the photoelectric detection switch 13 outputs a first signal. When the air outlet assembly 3 oscillates with the oscillating assembly 1 between the intermediate position and the second limit position, the baffle 211 is located outside the detection slot 131, and the photoelectric detection switch 13 outputs a second signal. The control assembly 4 is electrically connected to the photoelectric detection switch 13 and the driving member 12.

During the operation of the fan, the control assembly 4 obtains signals from the photoelectric detection switch 13. When the photoelectric detection switch 13 outputs the first signal, the baffle 211 is located within the detection slot 131, and the air outlet assembly 3 oscillates with the oscillating member 11 between the first limit position and the intermediate position. When the photoelectric detection switch 13 outputs the second signal, the baffle 211 is located outside the detection slot 131, and the air outlet assembly 3 oscillates with the oscillating member 11 between the intermediate position and the second limit position. When the first signal and the second signal output by the photoelectric detection switch 13 switch from one to the other, the air outlet assembly 3 oscillates with the oscillating member 11 to the intermediate position. Through the output signals of the photoelectric detection switch 13, the present disclosure enables the control assembly 4 to accurately detect the current position of the air outlet assembly 3, and the control assembly 4 can also control the oscillation angle of the air outlet assembly 3 via the driving member 12.

In one or more embodiments, the control assembly 4 includes an MCU 42 (Microcontroller Unit). The key points of the structural design of the baffle 211 are as follows. When the air outlet assembly 3 oscillates between the first limit position and the intermediate position, the baffle 211 is located within the detection slot 131, blocking the transmission and reception path of the photoelectric detection switch 13 and interrupting the signal. The MCU 42 of the control assembly 4 records the first signal as a low level when the photoelectric detection switch 13 is blocked by the baffle 211. When the air outlet assembly 3 oscillates between the intermediate position and the second limit position, the baffle 211 is outside the detection slot 131 and does not block the photoelectric detection switch 13. The MCU 42 records this second signal as a high level. When the air outlet assembly 3 oscillates leftward or rightward, the detection signal of the photoelectric detection switch 13 allows the MCU 42 to accurately capture the high-to-low or low-to-high transitions, and the transition point of the signal from high to low level or low to high level is recorded by the MCU 42 as the center point of the left-right oscillation of the air outlet assembly 3.

In one or more embodiments, the oscillating member 11 includes a connecting seat 111 and a mounting seat 112 that are connected to each other. The driving member 12 is connected to the connecting seat 111, and the air outlet assembly 3 is connected to the mounting seat 112. The mounting seat 112 is provided with a first through hole 1121, through which the fixed shaft 2 passes, and the mounting seat 112 is rotatably connected to the fixed shaft 2. In this embodiment, the photoelectric detection switch 13 is connected to the connecting seat 111. A bearing 113 is arranged between the first through hole 1121 and the fixed shaft 2, and the mounting seat 112 rotates relative to the fixed shaft 2 through the bearing 113. The connecting seat 111 and the mounting seat 112 can be connected by screws. When the air outlet assembly 3 oscillates with the oscillating member 11, the fixed shaft 2 remains stationary.

In one or more embodiments, the driving member 12 includes a driver 121 and a driving gear 122. The connecting seat 111 is provided with a first connection hole, and the driver 121 is connected to the first connection hole. The driver 121 is connected to the driving gear 122 and drives the driving gear 122. The top end of the fixed shaft 2 is provided with a semi-circular part 21. One portion of the semi-circular part 21 forms the baffle 211, the other portion of the semi-circular part 21 is provided with a toothed groove 212. The driving gear 122 engages with the toothed groove 212. When the driver 121 drives the driving gear 122 to rotate, the driving gear 122 engages and transmits motion through the toothed groove 212. Since the position of the toothed groove 212 is fixed, the driver 121 and the oscillating member 11 rotate, so that the driving member 12 drives the oscillating member 11 to rotate relative to the fixed shaft 2. In this embodiment, the driver 121 is a stepper motor.

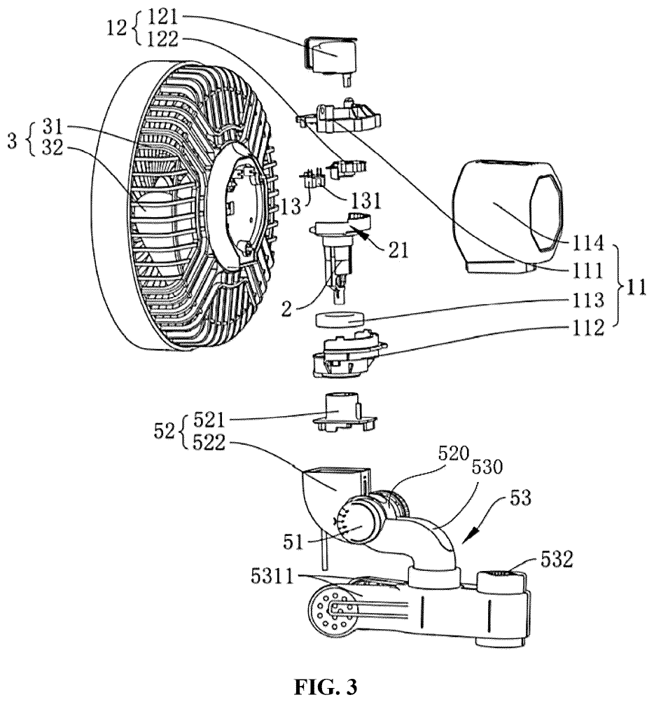

In one or more embodiments, as shown in FIGS. 3-5, the mounting seat 112 is provided with a receiving groove 1122 at its top end. The semi-circular part 21 is positioned within the receiving groove 1122. A first limiting protrusion 1123 is formed at the bottom of the receiving groove 1122. Two second limiting protrusions 213 are spaced apart on one side of the semi-circular part 21 adjacent to the bottom of the receiving groove 1122. The first limiting protrusion 1123 is located between the two second limiting protrusions 213. When the air outlet assembly 3 oscillates with the oscillating assembly 1 to the first limit position or the second limit position, the first limiting protrusion 1123 abuts against each of the two second limiting protrusions 213 respectively, thereby preventing the oscillation angle of the air outlet assembly 3 from being excessively large. It should be noted that, in the oscillation structure design of the air outlet assembly 3, the two second limiting protrusions 213 serve as the limit structures for the left and right oscillation of the air outlet assembly 3. When the air outlet assembly 3 oscillates to the first limit position or the second limit position, the oscillation is restricted, and the current of the stepper motor increases. When the air outlet assembly 3 reaches the limit structure, the control assembly 4 detects the variation in the current of the stepper motor caused by the restriction, thereby determining that the air outlet assembly 3 has reached the first limit position or the second limit position.

In one or more embodiments, the air outlet assembly 3 comprises a housing 31, fan blades 32, and a fan blade motor. The housing 31 covers the fan blades 32 and is connected to the mounting seat 112. The fan blade motor is drivingly connected to the fan blades 32 and electrically connected to the control assembly 4. In this embodiment, the control assembly 4 includes at least two buttons 41. When the at least two buttons 41 are triggered, the MCU 42 is enabled to respectively control the rotation signal of the fan blades 32 in the air outlet assembly 3 and the oscillation angle signal of the air outlet assembly 3. In this embodiment, the oscillating member 11 further includes an outer cover 114, and the buttons 41 are disposed at the top of the outer cover 114.

In one or more embodiments, as shown in FIGS. 2 and 3, the fan further includes a clamping assembly 5. The clamping assembly 5 includes a knob 51, a connecting member 52, and a clamping member 53. A first end of the clamping member 53 is configured to clamp a predetermined position, and a second end of the clamping member 53 is provided with a hinge groove 530. One end of the connecting member 52 is connected to the fixed shaft 2, and the other end is provided with a hinge protrusion 520. The hinge protrusion 520 is hinged within the hinge groove 530. One opposite side wall of the hinge groove 530 is provided with a through hole, and the other opposite side wall is provided with a threaded hole. The hinge protrusion 520 is provided with a second connection hole. The knob 51 extends through the through hole and the second connection hole and then is threadedly connected to the threaded hole. The knob 51 is configured to adjust a distance between the opposite side walls of the hinge groove 530. The fan is configured to be fixed by clamping a predetermined position through the first end of the clamping member 53, thereby facilitating the fixation of the fan. When it is necessary to adjust the pitch angle of the air outlet assembly 3, the knob 51 is loosened, allowing the connecting member 52 to rotate relative to the clamping member 53 to achieve pitch adjustment. After the air outlet assembly 3 is adjusted to a predetermined pitch angle, the knob 51 is tightened. At this time, the opposite side walls of the hinge groove 530 are pressed by the knob 51, thereby reducing the distance between the opposite side walls. The opposite side walls of the hinge groove 530 clamp the connecting member 52, so that the connecting member 52 is fixed relative to the clamping member 53, thereby enabling the air outlet assembly 3 to maintain the predetermined pitch angle.

In one or more embodiments, the connecting member 52 includes a connecting arm 521 and a connecting housing 522. The fixed shaft 2, the connecting arm 521, and the connecting housing 522 are sequentially connected. The hinge protrusion 520 is disposed on the connecting housing 522.

In one or more embodiments, a clip 531 is provided at a first end of the clamping member 53. Preferably, the clip 531 is provided with a clamping hole 5312, and the clamping hole 5312 is square-shaped. The clip 531 includes two clip arms 5311 that are elastically hinged around a shaft body, and the two clip arms 5311 form the clamping hole 5312 when closed together. Further preferably, an inner wall of the clamping hole 5312 is provided with a cushion pad 532. An outer wall of the cushion pad 532 has a serrated shape, which increases friction between the clamping hole 5312 and the predetermined position, thereby improving the installation strength and stability of the fan when mounted to the predetermined position.

In one or more embodiments, the fan according to the present disclosure is configured to adjust its oscillation angle by employing the method for adjusting the oscillation angle of the fan described in one or more embodiments of the present disclosure.

It should be noted that the foregoing description represents only preferred embodiments and the technical principles applied in the present disclosure. It will be understood by those skilled in the art that the present disclosure is not limited to the specific embodiments described herein. Various apparent modifications, rearrangements, and substitutions may be made without departing from the scope of protection of the present disclosure. Accordingly, although the present disclosure has been described in detail through the foregoing embodiments, it is not limited thereto. Additional equivalent embodiments may also fall within the scope of the present disclosure, which is defined by the appended claims.

What is claimed is:

1. A method for adjusting an oscillation angle of a fan, wherein the fan comprises an air outlet assembly, the air outlet assembly is configured to oscillate to a first limit position, an intermediate position, and a second limit position, wherein the intermediate position is located between the first limit position and the second limit position;
wherein the method comprises:
controlling the air outlet assembly to oscillate between the first limit position and the second limit position and acquiring a signal emitted by the fan in real time;
in response to acquiring a first signal emitted by the fan, determining that the air outlet assembly oscillates to a position between the first limit position and the intermediate position;
in response to acquiring a second signal emitted by the fan, determining that the air outlet assembly oscillates to a position between the intermediate position and the second limit position; and
in response to detecting a transition between the first and second signals emitted by the fan, determining that the air outlet assembly oscillates to the intermediate position.

2. The method according to claim 1, further comprising: an oscillation angle setting method, wherein the oscillation angle setting method comprises:
controlling the air outlet assembly to oscillate from the intermediate position to the first limit position;
acquiring a time period T1 during which the air outlet assembly oscillates from the intermediate position to the first limit position;
diving the oscillation angle of the air outlet assembly into M oscillation angle levels; and
when the fan operates at an N-th oscillation angle level, configuring the air outlet assembly to oscillate leftward and rightward from the intermediate position for a time period of N*T1/M, respectively.

3. The method according to claim 1, further comprising:
providing limiting structures respectively at both ends of an oscillating stroke of the air outlet assembly to restrict movement;
driving the air outlet assembly to oscillate by using a stepper motor; and
acquiring a variation value of a current of the stepper motor, and determining that the air outlet assembly oscillates to the first limit position or the second limit position when the current of the stepper motor increases.

4. The method according to claim 3, further comprising: an oscillation angle setting method, wherein the oscillation angle setting method comprises:
controlling the stepper motor to drive the air outlet assembly to oscillate from the intermediate position to the first limit position;
obtaining the number of steps A of the stepper motor when the air outlet assembly oscillates from the intermediate position to the first limit position;
dividing the oscillation angle of the air outlet assembly into M oscillation angle levels; and
when the fan operates at an N-th oscillation angle level, configuring the stepper motor to drive the air outlet assembly to oscillate leftward and rightward from the intermediate position by N*A/M steps, respectively.

5. A fan, comprising:
an oscillating assembly, wherein the oscillating assembly comprises an oscillating member, a driving member, and a photoelectric detection switch; wherein the photoelectric detection switch and the driving member are both disposed on the oscillating member, and the photoelectric detection switch is provided with a detection slot;
a fixed shaft, wherein the fixed shaft is provided with a baffle, and the driving member is configured to drive the oscillating member to rotate relative to the fixed shaft;
an air outlet assembly connected to the oscillating member, wherein the air outlet assembly is configured to oscillate with the oscillating assembly to a first limit position, an intermediate position, and a second limit position; wherein the intermediate position is located between the first limit position and the second limit position, when the air outlet assembly oscillates with the oscillating assembly between the first limit position and the intermediate position, the baffle is located within the detection slot, and the photoelectric detection switch outputs a first signal;
wherein, when the air outlet assembly oscillates with the oscillating assembly between the intermediate position and the second limit position, the baffle is located outside the detection slot, and the photoelectric detection switch outputs a second signal; and
a control assembly electrically connected to the photoelectric detection switch and the driving member.

6. The fan according to claim 5, wherein the oscillating member comprises a connecting seat and a mounting seat that are connected to each other, the driving member is connected to the connecting seat, the air outlet assembly is connected to the mounting seat, the mounting seat is provided with a first through hole, the fixed shaft passes through the first through hole, and the mounting seat is rotatably connected to the fixed shaft.

7. The fan according to claim 6, wherein the driving member comprises a driver and a driving gear;
wherein the connecting seat is provided with a first connecting hole, the driver is connected to the first connecting hole, the driver drives the driving gear, the top end of the fixed shaft is provided with a semi-circular part, one portion of the semi-circular part forms the baffle, the other portion of the semi-circular part is provided with a toothed groove, and the driving gear engages with the toothed groove.

8. The fan according to claim 7, wherein the top end of the mounting seat is provided with a receiving groove, the semi-circular part is located within the receiving groove, the bottom of the receiving groove is provided with a first limiting protrusion, two second limiting protrusions are spaced apart on one side of the semi-circular part closest to the bottom of the receiving groove, the first limiting protrusion is located between the two second limiting protrusions; and
when the air outlet assembly oscillates with the oscillating assembly to the first limit position or the second limit position, the first limiting protrusion abuts against each of the two second limiting protrusions respectively.

9. The fan according to claim 5, further comprising: a clamping assembly, wherein the clamping assembly comprises a knob, a connecting member, and a clamping member;
wherein a first end of the clamping member is configured to clamp a predetermined portion, a second end of the clamping member is provided with a hinge groove, one end of the connecting member is connected to the fixed shaft, the other end of the connecting member is provided with a hinge protrusion;
wherein the hinge protrusion is hinged within the hinge groove, one opposite side wall of the hinge groove is provided with a through hole, the other opposite side wall is provided with a threaded hole, the hinged protrusion is provided with a second connection hole;
wherein the knob extends through the through hole and the second connection hole, and the knob is threadedly connected to the threaded hole and is configured to adjust the distance between the opposite side walls of the hinge groove.

10. The fan according to claim 9, wherein the first end of the clamping member is provided with a clip, the clip is provided with a clamping hole, the clamping hole is square-shaped, and an inner wall of the clamping hole is provided with a cushion pad, an outer wall of the cushion pad has a serrated shape.
